(19) United States
(12) Patent Application Publication
(10) Pub. No.: US 2024/0016104 A1
(43) Pub. Date: Jan. 18, 2024

(54) AIR DAM FACILITATING DEBRIS COLLECTION

(71) Applicant: Randy Nass, Kennesaw, GA (US)

(72) Inventor: Randy Nass, Kennesaw, GA (US)

(21) Appl. No.: 18/354,268

(22) Filed: Jul. 18, 2023

Related U.S. Application Data
(60) Provisional application No. 63/383,283, filed on Nov. 11, 2022.
(60) Provisional application No. 63/389,980, filed on Jul. 18, 2022.

(51) Int. Cl. A01G 20/47

(52) U.S. Cl. CPC A01G 20/47

(57) ABSTRACT

A Y-shaped air dam with a central frame configured to facilitate the focusing of air from a lawn and leaf blower for the collection of leaves and similar lawn debris into collection containers, exhibiting two panels connected to a central frame. The central frame is equipped with retaining clips configured to facilitate attachment of a collection container such as a paper bag to the central frame securely without tools. The two panels pivot about hinges and may be removed from the central frame for storage or folded up when not in use. Stakes may be used to anchor the panels to the ground during use. A companion device may be included which is configured to perforate collection containers such as bags to provide for the passage of air through the containers during use.

### CONTINUITY

This application is a non-provisional patent application of provisional patent application No. 63/383,283, filed on Nov. 11, 2022, and of provisional application No. 63/389,980, filed on Jul. 18, 2022, and priority is claimed thereto.

### FIELD OF THE PRESENT INVENTION

The present invention relates to the field of sanitation and lawn care, and more specifically relates to air dam and collection apparatus configured to facilitate the collection of debris, such as lawn debris and/or trash, into a container via a lawn and leaf blower, broom, rake, or similar apparatus.

### BACKGROUND OF THE PRESENT INVENTION

Lawn care requires a good deal of repetitive motion and hard work. From general maintenance of mowing grass, removing weeds, leaf removal, general cleaning, trimming, and edging driveways and sidewalks, a large amount of time can be spent generating lawn debris. Generally, one caring for a lawn or garden is encouraged to collect any and all lawn debris such as grass clippings, leaves, pulled weeds, and twigs near the end of the job in order to ensure that the lawn or garden is properly cared for and looks its best.

Unfortunately, leaf, trash, or other debris collection can be especially laborious. It often requires the repetitive motion of bending over numerous times in order to pick up the leaves, either by using a rake as a form of shovel or simply by hand, and placing the leaves (and other debris) into a collection bag or bin. A leaf blower is a good tool for collecting leaves or other debris into a broad general location, but due to the nature of air blowing in the outdoors, natural crosswinds may often make it challenging to gather the debris in one location. It is difficult to precisely blow the leaves/debris into a general type of collection container. Therefore, there is usually another step required in the process: manually bending repetitively over to collect the leaves and placing them into the container. Alternately, some individuals use a leaf blower to blow the leaves into a large pile atop a tarp which may then be used, awkwardly, to siphon then pickup and dump the leaves into the container.

If there were a way in which the process of leaf and debris clean-up could be expedited and made to be easier through the use of a conventional leaf blower, lawn care would be a faster and more enjoyable activity.

Thus, there is a need for a new apparatus and process of use thereof for the collection of leaves, lawn debris, trash, and general debris into a specialized collection container. Such an apparatus preferably focuses the air blown from a leaf blower via one or more air dams to ensure that the leaves are blown directly into the collection container in a deliberate, less chaotic manner, minimizing the repetitious work required to collect lawn and other debris and expediting the process.

### SUMMARY OF THE PRESENT INVENTION

The present invention is an air dam and lawn/leaf and debris collection container connector configured to facilitate and expedite the pickup and removal of lawn/leaf/trash debris such as leaves, sticks, grass clippings, weeds, trash, miscellaneous debris and the like from a lawn or garden. The apparatus employs at least two panels, configured to be oriented at an obtuse angle to enable the direction and concentration of air blown from a leaf blower into a central container for easy lawn and leaf debris collection.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts a view of the apparatus of the present invention as seen from the front and side, constructed for use on a lawn or garden.

FIG. 2 exhibits a flow chart detailing the process of use of the apparatus of the present invention by a user in the collection of lawn debris.

FIG. 3 shows a close-up view of the front of the central frame of the present invention, showing the preferred embodiment of the hinges of the present invention.

FIG. 4 shows an exploded perspective view of the companion device of the present invention configured to create perforations in the collection bag(s) used with the present invention.

FIG. 5 depicts a view of the frame of one preferred embodiment of the present invention, composed of hollow PVC piping components.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

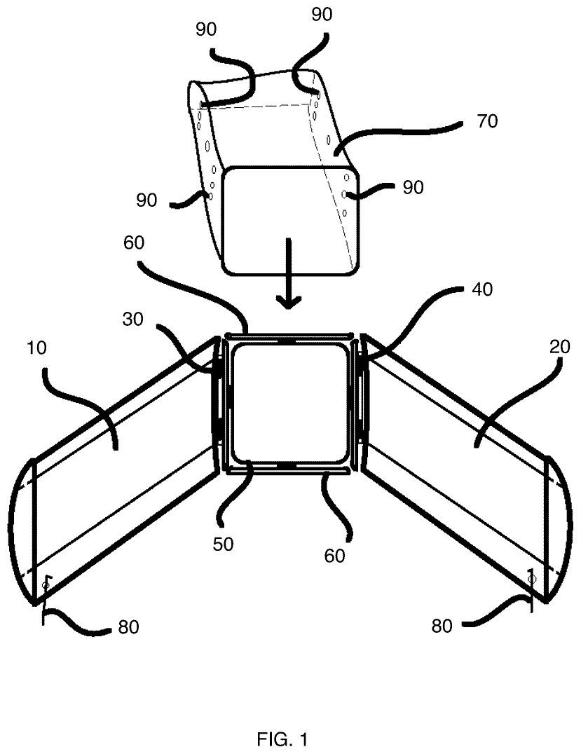

The present invention is a debris collection system configured to facilitate and expedite the collection of lawn debris such as leaves, grass clippings, twigs, weeds, trash, and miscellaneous debris into a collection container. The preferred embodiment of the present invention exhibits a first air dam panel (10), a second air dam panel (20), a first hinge (30), a second hinge (40), and a central frame (50). The first air dam panel (10) is connected to the central frame (50) via the first hinge (30), and the second air dam panel (20) is connected to the central frame (50) via the second hinge (40), as shown in FIG. 1. Each the first hinge (30) and the second hinge (40) may be implemented in a long hinge which encompasses a majority of the side of the central frame (50), or two smaller hinges disposed on each side (for a total of four hinges) as depicted in FIG. 1.

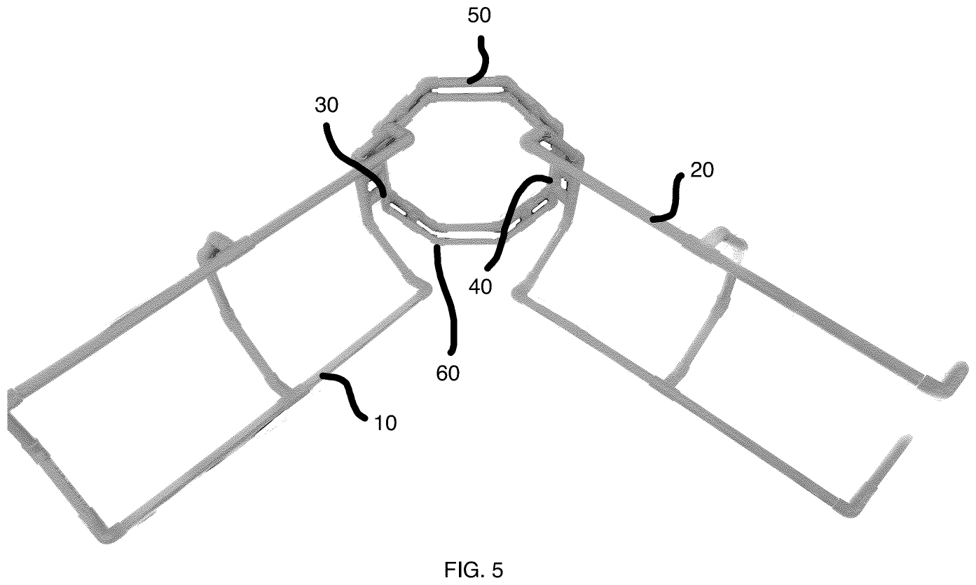

In preferred embodiments of the present invention as shown in FIG. 5, the first hinge (30) and second hinge (40) are effectively built-in to the structure of the apparatus, as the frame of the apparatus is composed of interlocked PVC piping segments (or similar cylindrical hollow components), coupled together with elbow joints, 45-degree joints, and T-shaped joints (three-way joints). In such embodiments the first hinge (30) and second hinge (40) need not be traditional hinges, but instead pivot by movement of male PVC pipe ends within the joints. As such, the segments designed to pivot and act as the first hinge (30) and second hinge (40) are not equipped with sealant or glue. In such preferred embodiments, the first air dam panel (10) and second air dam panel (20) are equipped with a frame which is also composed of PVC segments, or similar hollow piping configured to interlock. A membrane, such as, but not limited to, a tarp, wind-sock, canvas, or other material is employed to be bound to the PVC frame to form the completed first air dam panel (10) and second air dam panel (20). Further, the central frame (50) is also composed of interlocking piping segments, present in the shape of an octagon. Alternately, other shapes may be constructed, however the octagon provides for vertical right and left sides of the central frame (50), facilitating the connection of the air dam panels (10, 20) to the central frame (50) such that they may pivot horizontally to a desired angle with ease. A total of 26 linear PVC piping segments are used in the construction of the air dam panels (10, 20), with an additional 8 T-shaped connectors and 8 elbow joints. Further, an additional 24 obtuse angled (45-degree) connectors (in total) are used to assemble the first air dam panel (10) and the second air dam panel (20). Per this arrangement, the air dam panels (10, 20) can be fully opened out to 180-degrees, or closed at 0-degrees for easy storage. It should be understood that the air dam panels (10, 20) can be opened to any extent between 0-180 degrees as desired by the user.

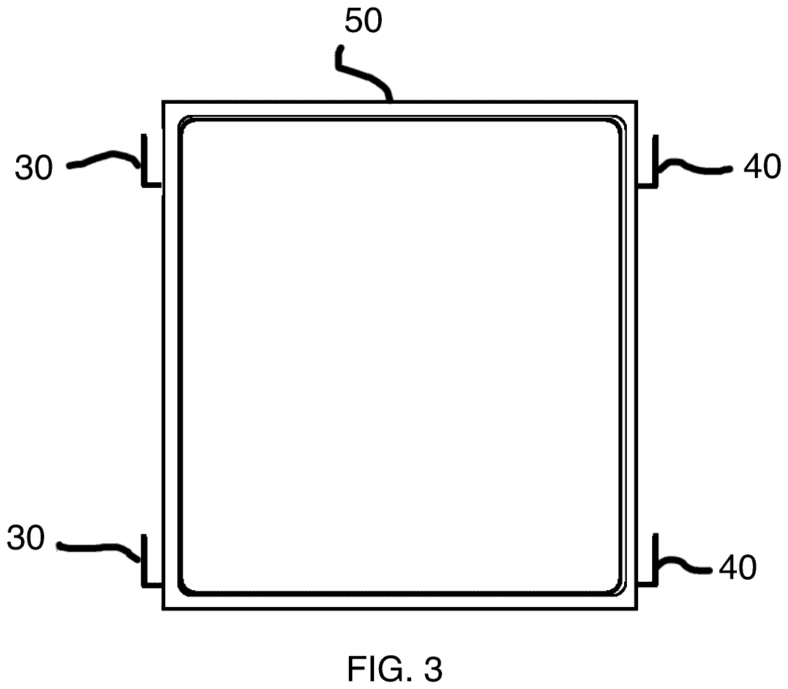

In some embodiments of the present invention, the first hinge (30) and second hinge (40), one of each being present on each the right side and the left side of the central frame, are disposed as L-shaped pins as depicted in FIG. 3. In such preferred embodiments, the first air dam panel (10) and second air dam panel (20) are configured to attach to the central frame (50) by sliding receivers over each L-shaped pin of each hinge (30, 40). This arrangement enables movement of the air dam panels (10, 20) about the hinge as needed, as well as facilitates removal of the air dam panels (10, 20) when desired for storage.

The central frame (50) is equipped with retaining clasps (60) configured to facilitate the secure connection of a collection container (70) such as a paper bag, plastic bag, cardboard, or other perforated container to the central frame (50). Ground stakes (80) are preferably bundled with the apparatus of the present invention, and are configured to ensure that the first air dam panel (10) and second air dam panel (20) remain stationary when in use, even against the movement of air originating from a leaf blower during the debris collection process. In some embodiments of the present invention, the ground stakes (80) are affixed to the first air dam panel (10) and second air dam panel (20) respectively, and preferably fold down so that they may be inserted into the ground. In other embodiments, the ground stakes (80) are separate, and are configured to first pass through loops present on the first air dam panel (10) and second air dam panel (20).

Upon setup of the apparatus of the present invention, a “Y-shaped” funnel is formed which exhibits a central release point out of the back where the lawn and other debris is collected in the container (70) affixed to the central frame (50). To ensure air passage, holes (90) are present in the collection container (70) which are large enough to enable air passage even with debris in the container (70) while small enough to ensure that the leaves and debris do not flow out from the container (70). Collection containers (70) not equipped with holes (90) may be used if the user does not use a leaf blower, but instead uses a rake or broom.

Preferred embodiments of the present invention are bundled with a hole-punching platform (100) configured to facilitate the quick and easy perforation of generic paper lawn and leaf bags to enable their use with the apparatus of the present invention.

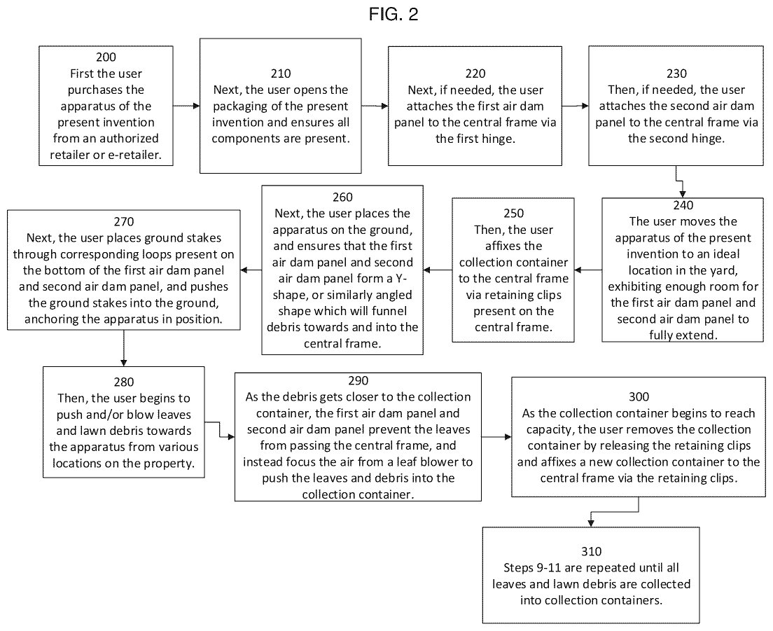

The method of use of the apparatus of the present invention, as detailed in FIG. 2, is preferably as follows:
1. First the user purchases the apparatus of the present invention from an authorized retailer or e-retailer. (200)
2. Next, the user opens the packaging of the present invention and ensures all components are present. (210)
3. Next, if needed, the user attaches the first air dam panel to the central frame via the first hinge. (220)
4. Then, if needed, the user attaches the second air dam panel to the central frame via the second hinge. (230)
5. The user moves the apparatus of the present invention to an ideal location in the yard, exhibiting enough room for the first air dam panel and second air dam panel to fully extend. (240)
6. Then, the user affixes the collection container to the central frame via retaining clips present on the central frame. (250)
7. Next, the user places the apparatus on the ground, and ensures that the first air dam panel and second air dam panel form a Y-shape, or similarly angled shape which will funnel debris towards and into the central frame. (260)
8. Next, the user places ground stakes through corresponding loops present on the bottom of the first air dam panel and second air dam panel, and pushes the ground stakes into the ground, anchoring the apparatus in position. (270)
9. Then, the user begins to push and/or blow leaves and lawn debris towards the apparatus from various locations on the property. (280)
10. As the debris gets closer to the collection container, the first air dam panel and second air dam panel prevent the leaves from passing the central frame, and instead focus the air from a leaf blower to push the leaves and debris into the collection container. (290)
11. As the collection container begins to reach capacity, the user removes the collection container by releasing the retaining clips and affixes a new collection container to the central frame via the retaining clips. (300)
12. Steps 9-11 are repeated until all leaves and lawn debris are collected into collection containers. (310)

It should be understood that various alternate embodiments of the present invention are envisioned to be manufactured of a variety of materials including, but not limited to vinyl, nylon, plastic, metal, and fabrics. In some embodiments of the present invention, the first air dam panel (10) and second air dam panel (20) are configured to fold up beyond that which is afforded by the first hinge (30) and second hinge (40). Additionally, it should be understood that various embodiments of the present invention may be manufactured in a variety of colors, shapes, and textures, however it is preferably envisioned that the first air dam panel (10) and second air dam panel (20) are rectangular in nature, and may exhibit rounded corners as depicted in FIG. 1.

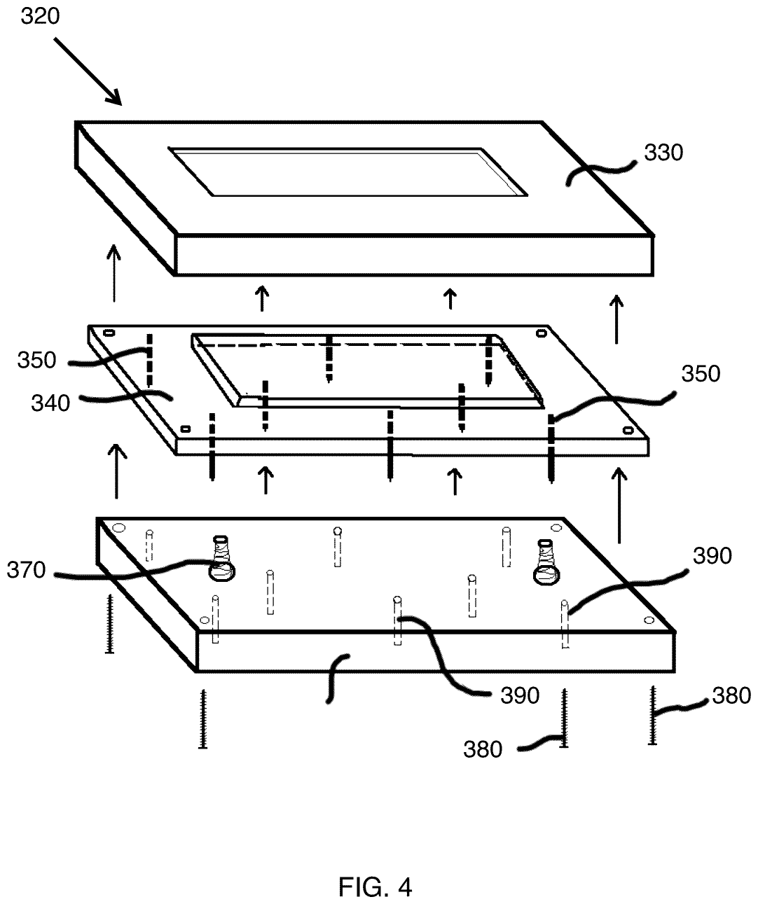

As depicted in FIG. 4, a companion device (320) may be bundled with the present invention upon purchase, or may be purchased separately. The companion device (320) facilitates the punching of holes (90) in a bag configured to be employed as the collection container (70) with the apparatus of the present invention. The companion device (320) is equipped with a carriage box (330), a push pin plate (340), pins (350) disposed in communication with the push pin plate (340), a base (360), springs (370) disposed on the base (360), and screws (380) configured to secure the push pin plate (340) to the base (360). When compressed with a collection container (70) disposed atop the pins (350), the pins (350) will puncture the holes (90) into the collection container (70), passing into pin hole recesses (390) disposed within the base (360) as shown in FIG. 4.

In some alternate embodiments of the present invention, the first air dam panel (10) and second air dam panel (20) are composed of a fabric tarp which is supported by interlocking poles similar to those employed in tent construction. In such embodiment, a flat hood may be present, extending between both the first air dam panel (10) and second air dam panel (20) to more effectively contain any leaves/debris from evading the collection container (70) by coming up and over the collection container (70). Such embodiments make it easier to store the air dam panels as the fabric tarp construction may be rolled up and placed into a storage bag. The interlocking poles, referenced as rods, are preferably connected together with elbow joints at the corners of the first air dam panel (10) and second air dam panel (20). There are preferably four elbow joints and four rods for each panel.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A debris collection apparatus comprising:
a container, said container equipped with a top, side walls, and a bottom;
a central frame, said central frame disposed in communication with said top of said container;
a first air dam panel, said first air dam panel disposed in communication with said central frame via a first hinge;
a second air dam panel, said second air dam panel disposed in communication with said central frame via a second hinge, opposite said first air dam panel;
wherein said first air dam panel and said second air dam panel are equipped with membranes; and
wherein said container, said first air dam panel, and said second air dam panel form a Y-shape.
